(19) United States
(12) Patent Application Publication
(10) Pub. No.: US 2019/0126195 A1
(43) Pub. Date: May 2, 2019

(54) EXTERNAL GAS MIXING PIPE FOR LIQUID-GAS CONTACTING UNIT

(71) Applicants: TOTAL SA, Courbevoie (FR); PROSERNAT, Paris - La Défense (FR); IFP ENERGIES NOUVELLES, Rueil Malmaison (FR)

(72) Inventors: Claire WEISS, Vaucresson (FR); Thomas MAUBERT, Paris (FR); Gauthier PERDU, Suresnes (FR); Clément SALAIS, Paris (FR); Vincent CARLIER, Lyon (FR); Pascal ALIX, Roussillon (FR); Manel FOURATI, Lyon (FR); Philippe BEARD, Saint Genis Laval (FR)

(73) Assignees: T0TAL SA, Courbevoie (FR); PROSERNAT, Paris - La Défense (FR); IFP ENERGIES NOUVELLES, Rueil Malmaison (FR)

(21) Appl. No.: 16/098,798

(22) PCT Filed: May 3, 2016
(86) PCT No.: PCT/IB2016/000765

§ 371 Date: Nov. 2, 2018

(51) Int. Cl. B01D 53/18; B01D 3/00; B01D 3/32; B01D 3/28; B01D 53/14; C10L 3/10

(52) U.S. Cl. CPC B01D 53/185; B01D 3/008; B01D 3/32; B01D 3/28; B01D 53/1475; C10L 2290/541; C10L 3/104; C10L 3/106; C10L 3/101; B01D 2252/504; B01D 2252/204; C10L 3/103

(57) ABSTRACT

The present invention relates to a liquid-gas contacting unit comprising a column, at least a lower packed bed and a higher packed bed positioned higher than the lower packed bed inside the column, a gas-tight liquid collecting and redistributing device disposed between the lower and the higher packed bed inside the column and an external pipe outside the column, the external pipe comprising an inlet end, an outlet end and a peripheral wall between the inlet end and the outlet end; the inlet end being positioned between the lower pack bed and the gas-tight liquid collecting and redistributing device and the outlet end being positioned between the higher pack bed and the gas-tight liquid collecting and redistributing device. The present invention also relates to a method for improving the efficiency of a liquid-gas contacting unit.

### RELATED APPLICATIONS

The present application is a National Phase entry of PCT Application No. PCT/IB2016/000765, filed May 3, 2016, said application being hereby incorporated by reference herein its entirety.

### FIELD OF THE INVENTION

The present invention relates to the improvement of gas processing efficiency in an oscillating liquid-gas contacting unit placed on a floating support.

### BACKGROUND OF THE INVENTION

Raw natural gas, coming primarily from crude oil wells, gas wells and condensate wells, comprises varying amounts of contaminants such as acid gases (carbon dioxide (CO₂), hydrogen sulfide (H₂S), and mercaptans such as methanthiol), water and mercury. To be marketed, raw natural gas must be purified in natural-gas-processing plants to meet the quality standards specified by the distribution companies or the LNG specifications. A natural-gas processing plant comprises different process units to remove impurities such as several liquid-gas contacting units that removes acid gas and water, and adsorption units to remove different types of contaminants, for example mercury. These liquid-gas contacting units operate under counter-current or co-current liquid-gas flow conditions.

A conventional packed column of a liquid-gas contacting unit operating under counter-current liquid-gas flow conditions is a cylindrical column equipped with a gas outlet at the top, a liquid outlet at the bottom, a gas inlet and a liquid inlet positioned either respectively at the bottom and top or both at the vicinity of the middle of the column, a plurality of packed beds and a column internal between two packed beds. In operation, a liquid stream is circulated downwards and the gas to be treated is circulated upwards. Liquid and gas are contacted in the packed beds. For example, raw natural gas is contacted with an aqueous amine solution to remove acid gases from the natural gas. The treated natural gas is recovered at the top of the column, while the acidified aqueous amine solution is recovered at the bottom of the column. The column internal collects the liquid to redistribute the collected liquid from one higher packed bed to a lower packed bed while allowing gas to pass through.

The natural-gas processing plant may further comprise a liquefaction unit for liquefying the treated natural gas for ease of storage or transport. Until now, liquefied natural gas has been produced in onshore natural-gas processing plants built, thereby comprising onshore liquid-gas contacting unit. But offshore technologies have been developed since the mid-1990's to treat and liquefy raw natural gas on a floating support. For example, offshore columns can be installed on vessels, floating barges or offshore platforms, of FPSO (Floating Production, Storage and Offloading) type or of FLNG (Floating Liquefied Natural Gas) type for example. Floating barges may also comprise distillation columns or dehydration columns.

FLNG technology provides a number of environmental advantages such as reducing the environmental footprint of the project and preserving marine and coastal environments, since the whole processing is done at the gas-extraction site, i.e. there is no need to build pipelines and to use compression units to pump the gas from the off-shore gas field and bring it on shore, or to build an oil platform or an onshore natural-gas processing plant. FLNG technology also provides a number of economic advantages, for example, pumping gas to the shore can be prohibitively expensive due to the construction of pipelines.

However, the current FLNG technology challenge is that each element of the natural-gas processing plant and liquefaction unit needs to fit into a floating support having limited space, while maintaining appropriate levels of safety and achieving the desired specification.

To rise to the above challenge, it is necessary to consider the impact of motion due to waves and weather on the floating support first to secure the floating support and then optimize the design of the process units, in particular the liquid-gas contacting units.

The floating support motion can cause the liquid-gas contacting unit to move away from the vertical orientation, which is generally the orientation considered during design of the units. The motion of the liquid-gas contacting unit, and thus the resulting angular acceleration of the liquid-gas contacting unit, has a significant impact on liquid distribution within the packing beds, leading to the appearance of wetted zones differentiated by the liquid load therethrough. This phenomenon is known as the liquid maldistribution, i.e. some wetted zones receive more liquid than others so that in overall, different gas portions are treated unevenly. Wetted zones can be sorted into underloaded areas or overloaded areas according to the liquid load therethrough. In an underloaded area, the gas is not effectively treated, while in an overloaded area, the gas is over-treated. It results in an inhomogeneity of the composition of the gas and irregularity of the gas treatment. It impairs the efficiency of the liquid-gas contacting unit. This may significantly impact the column design basis (increased diameter and height of the column of the liquid-gas contacting unit are needed to compensate the loss of efficiency) and consequently the whole FLNG project.

Industrial feedback on floating support is limited and does not allow precise predictions on this global loss of gas treatment efficiency of the liquid-gas contacting unit. Extrapolations from past experience on floating support to liquid-gas contacting unit are mainly based on dehydration applications or separation columns (Cullinane, Yeh, Grave, 2011 “Effect of Tower Motion on Packing Efficiency”, SPE 143766, Brasil Offshore Conference, Macaé, Brazil). Literature (Kobayashi et al., “An experimental study on the behaviour of the two types of absorption towers installed in the float type LNG facilities”, AIChE National Meeting, 118C, 1999; Yoshinaga et al., “Effects of barge motion on absorption column”, 90^{th} AICHE national meeting, Houston, 5-9 April, Prepr. N26D 25P, 1981; Berger et al., “LNG production on marine structures with clarification of motion influence on absoprtion and rectification”, Seventh International Conference on Liquefied Natural Gas, Vol 1&2, Sessions I et II, 1983; Tanner et al. “Modelling the performance of a packed column subjected to tilt”, Tran IChemE, vol 74, Part A, 177-182, 1996) indicates that the performance of packed beds could be decreased by up to 60%. This global loss of efficiency depends highly on the system (separation, absorption), the gas/liquid contactor (packing, tray) and the overall geometry and location of the column on board the floating support.

Due to the global loss of efficiency of the gas treatment, it was contemplated to increase the column capacity, e.g. by increasing the size of the column. However, this would increase constraints exerting onto the structure of the floating support itself. This means that the size of the floating support would be so large, that economic feasibility of the project can be jeopardized.

Numerical simulations have shown that, the efficiency of the liquid-gas contacting unit decreases drastically if the gas is not homogeneous. Different devices have been contemplated to compensate for the loss of efficiency of the liquid-gas contacting unit such as those described in U.S. Pat. No. 4,820,455, WO 2014/070352 and WO 2015/090476. These devices are disposed between two packed beds inside column of the liquid-gas contacting unit. They are all based on the principle of mixing the gas to homogenize said gas and then evenly redistributing the homogenous gas inside the column of the liquid-gas contacting unit.

### SUMMARY OF THE INVENTION

One aspect of the invention is a liquid-gas contacting unit comprising:
a column,
at least a lower packed bed and a higher packed bed positioned higher than the lower packed bed inside the column,
a gas-tight liquid collecting and redistributing device disposed between the lower and the higher packed bed inside the column;
   and characterized in that,

it further comprises an external pipe outside the column, the external pipe comprising an inlet end, an outlet end and a peripheral wall between the inlet end and the outlet end; and in that the inlet end of the external pipe is positioned between the lower pack bed and the gas-tight liquid collecting and redistributing device and the outlet end of the external pipe is positioned between the higher pack bed and the gas-tight liquid collecting and redistributing device.

Thanks to the external pipe, in operation, the gas flowing upwards from the lower packed bed can be extracted from the column, contracted inside the external pipe and injected back to the higher packed bed inside the column and at the same time be mixed and homogenized in between, i.e. gas mixing and homogenizing happen outside the column. It has been discovered that this results in a more homogenized treatment of the gas flowing upwards and the efficiency of the liquid-gas contacting unit is improved.

Additionally or alternatively, the column has an internal mean cross section S_{ci} and the external pipe an internal mean cross section Sₚᵢ, such that Sₚᵢ is 0.1% to 20% of S_{ci}.

Additionally or alternatively, the liquid-gas contacting unit further comprises a gas mixer inside the external pipe. The gas mixer may be static one or more mixers, one or more orifice plates, one or more blades or one or more baffles.

Additionally or alternatively, the liquid-gas contacting unit further comprises a heat exchanger with which the gas flowing through the external pipe is put into thermal contact.

Additionally or alternatively, the liquid-gas contacting unit further comprises a gas redistributor between the higher pack bed and the gas-tight liquid collecting and redistributing device. The gas redistributor may be a gas dispenser, gas deflector or a gas distributor plate with chimney.

Additionally or alternatively, the liquid-gas contacting unit comprises n gas-tight liquid collecting and redistributing devices numbered from 1 to n, n+1 packed beds numbered from 1 to n+1 inside the column and n external pipes numbered from 1 to n outside the column. The gas-tight liquid collecting and redistributing device j is positioned between packed bed j and packed bed j+1 above packed bed j, and the inlet end of external pipe j is positioned between packed bed j and gas-tight liquid collecting and redistributing device j, and the outlet end of external pipe j is positioned between packed bed j+1 and gas-tight liquid collecting and redistributing device j.

Additionally or alternatively, the liquid-gas contacting unit comprises m external pipes, with m, an integer, from 1 to 10, in particular 1 to 4, more particularly m is 1. The inlet ends of the m external pipes are positioned between the lower pack bed j and the gas-tight liquid collecting and redistributing device j and the outlet ends of the m external pipes are positioned between the higher pack bed j+1 and the gas-tight liquid collecting and redistributing device j.

Additionally or alternatively, the column presents an inner surface and the gas-tight liquid collecting and redistributing device is tightly fixed to the inner surface.

Additionally or alternatively the liquid-gas contacting unit operates under counter-current or co-current liquid-gas flow conditions.

Additionally or alternatively the liquid-gas contacting unit is an absorption unit, a separation unit or a heat exchange unit.

Another aspect of the invention is a method for improving the efficiency of a liquid-gas contacting unit as described above by directing the gas from the lower packed bed to the higher packed bed through the external pipe.

Additionally or alternatively, the pressure drop between the higher packed bed and the lower packed bed is 5 mbar to 100 mbar, in particular 25 mbar to 75 mbar, more particularly 50 mbar.

Additionally or alternatively, the temperature of the gas is changed inside the external pipe.

Additionally or alternatively, the temperature change of the gas between the inlet end and outlet end of the external pipe is −50° C. to +50° C., in particular −30° C. to +30° C.

Another aspect of the invention is a floating support comprising the liquid-gas contacting unit described above.

### BRIEF DESCRIPTION OF THE FIGURES

Further objectives, features and advantages of the present invention will become apparent upon reading the following description with reference to the illustrative and non-limiting drawings, amongst which:

FIG. 1 is a schematic inner representation of a liquid-gas contacting unit operating under counter-current liquid-gas flow conditions according to the present invention.

### DETAILED DESCRIPTION OF THE FIGURES

The present invention is more precisely described below with reference to a gas flowing upwards from a lower packed bed to a higher packed bed positioned higher than the lower packed bed in a liquid-gas contacting unit, while a liquid streams downwards from the upper packed bed to the lower packed bed. However, the present invention is not limited to this particular described embodiments and it will be obvious to the person skilled in the art that various changes and modifications can be made without departing from the scope of the invention.

Further, in the present disclosure, the words, “upper”, “higher”, “top”, “lower”, “bottom” and “above” are used to describe the operating position of the devices and components of the devices according to the invention and as such are to be considered with reference to the devices in their operating position.

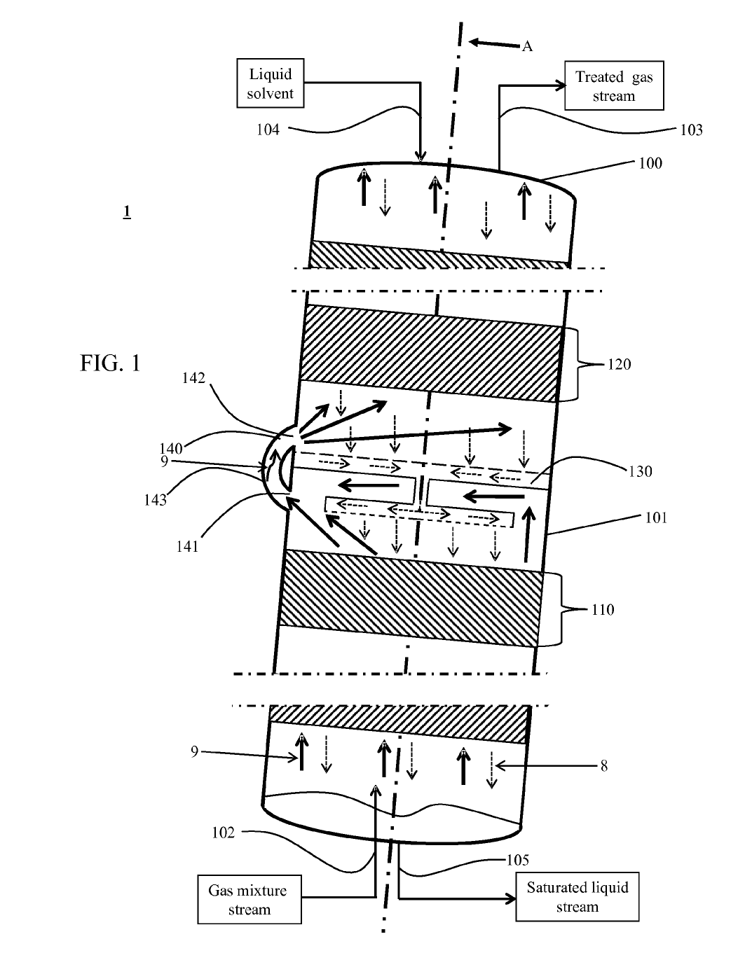

A liquid-gas contacting unit is described hereafter with reference to FIG. 1.

The liquid-gas contacting unit 1 of the present invention comprises a column 100, at least a lower packed bed 110 and a higher packed bed 120 positioned higher than the lower pack bed 110 inside the column 100, a gas-tight liquid collecting and redistributing device 130 disposed between the lower and the higher packed bed 110, 120 inside the column 100. The liquid-gas contacting unit 1 further comprises an external pipe 140 outside the column 100, the external pipe 140 comprises an inlet end 141, an outlet end 142 and a peripheral wall 143 between the inlet end 141 and the outlet end 142. In the liquid-gas contacting unit 1, the inlet end 141 of the external pipe 140 is positioned between the lower pack bed 110 and the gas-tight liquid collecting and redistributing device 130 and the outlet end 142 of the external pipe 140 is positioned between the higher pack bed 120 and the gas-tight liquid collecting and redistributing device 130.

In operation, a liquid 8 streams downwards from the higher packed bed 120 to the lower packed bed 110 through the gas-tight liquid collecting and redistributing device 130. Since the liquid collecting and redistributing device 130 is gas-tight, all the gas 9 is collected and directed from the lower packed bed 110 to the higher packed bed 120 through the external pipe 140 by entering the external pipe 140 through the inlet end 141 and exiting therefrom through the outlet end 142.

The external pipe 140 is configured so that the gas 9 is mixed there inside to obtain a homogeneous gas which is distributed to the higher packed bed 120. Thus, the efficiency of the liquid-gas contacting unit 1 is improved.

The liquid-gas contacting unit 1 may further comprise a heat exchanger, with which the gas flowing through the external pipe 140 will be put into thermal contact, thereby changing the temperature of the gas 9, i.e. heating or cooling the gas 9 inside the external pipe 140 and thus improving further the efficiency of the liquid-gas contacting unit 1.

Packed Bed

In the liquid gas-contacting unit 1 of the present invention, each packed bed 110, 120 may be a hollow tube, pipe, or other type of vessel. It is a device filled with a packing material. The packing material may consist of small objects, such as Raschig® rings, randomly filling the packed bed. The packing material may also be a specifically structured packing typically consisting of corrugated metal plates. In all cases, the packing material improves the contact between the liquid and the gas over a large contact area.

Column

The column 100 typically presents a longitudinal axis A and an inner surface, a gas outlet 103 at its top and a liquid outlet 105 at its bottom 101. Moreover, the column 100 has typically an internal cross section and an internal mean cross section S_{ci}.

In the following, “cross section” taken at one point is understood as the section with the smallest area going through this point. As such, “mean cross section” is the average between the cross sections at all points.

The column 100 may present a cylindrical shape, preferably a right circular cylinder. The column 100 may alternatively comprise at least one frustoconical portion and at least two cylindrical portions connected to each other by the frustoconical portion so that the internal cross section of the column 100 varies along its length.

The liquid-gas contacting unit 1 may operate under counter-current or co-current liquid-gas flow conditions. For example, the liquid-gas contacting unit 1 may be an absorption unit, a separation unit or a heat exchange unit.

The liquid-gas contacting unit 1 may also be a floating offshore liquid-gas contacting unit or an onshore liquid-gas contacting unit.

A column 100 of an absorption unit further comprises a liquid inlet 104 at its top through which a liquid is injected into said column 100 forming a liquid stream, and a gas inlet 102 at its bottom through which a gas 9 is provided as a gas mixture. The gas mixture is intended to be treated by the liquid. As such, the liquid is a solvent intended to absorb preferentially one or more gaseous components of the gas mixture flowing from the bottom to the top of the column 100 which are wished to be removed from the gas mixture.

In the lower and higher packed beds 110, 120, the gas mixture 9 flowing upwards and the liquid stream 8 falling downwards are contacted so that the one or more gaseous components of the gas mixture 9 are preferentially absorbed. A treated gas stream, having a lower concentration of the one or more gaseous components, is recovered at the top of the column 100 of the absorption unit through the gas outlet 103. A saturated liquid stream, having a higher concentration of the one or more gaseous components, is recovered at the bottom of the column 100 of the absorption unit through the liquid outlet 105.

The absorption unit may be an acid gas absorption unit wherein the acid gas is for example carbon dioxide (CO₂) or hydrogen sulfide (H₂S), and the liquid solvent is for example an amine diluted in water or a mixture of amines diluted in water or a mixture of amine plus chemical molecules like sulfolane or thio-glycols diluted in water or a physical solvent such cold methanol or alkyl ethers of polyethyleneglycol (DMPEG).

The absorption unit may also be a dehydration unit wherein glycols (for example triethylene glycol, diethylene glycol, ethylene glycol, and tetraethylene glycol or mixtures thereof) form a liquid desiccant system that removes gaseous water from gas mixture, such as natural gas.

A column of a separation unit further comprises an inlet for feeding said column with a feed stream comprising a mixture of chemical components (not represented in the figures). The inlet is more typically placed at mid-height, although it may be placed anywhere else in the vicinity of the mid-height. In the packed beds, the chemical components are physically separated into a gas portion and a liquid portion. The separation is based on differences in the chemical components' boiling points and vapor pressures at specified operation temperatures and operation pressures. Condensation and vaporization of the chemical compounds occur in each packed bed, causing lower boiling point components to rise to the top of the separation column and higher boiling point components to fall to the bottom. A gas is recovered at the top of the column of the separation unit through the gas outlet, while a liquid is recovered at the bottom of the column through the liquid outlet.

A column 100 of a heat exchange unit further comprises a liquid inlet 204 at its top through which a liquid is injected into said column 100 forming a liquid stream, and a gas inlet 202 at its bottom through which a gas is provided as a gas stream. The gas stream and the liquid stream are intended to exchange heat. Depending on heat capacity of the gas stream and the liquid stream:
a hotter gas is recovered at the top of column 100 through the gas outlet 103, while a colder liquid is recovered at the bottom of the column 100 through the liquid outlet 105, or
a colder gas is recovered at the top of the column 100 through the gas outlet 103, while a hotter liquid is recovered at the bottom of the column 100 through the liquid outlet 105.

The liquid-gas contacting unit 1 may be provided on a floating support, such as an ocean vessel or on barges designed for lakes, bayous, and smaller bodies of water. Because the support is a floating support, it is subjected to movement of the water body, which may cause the liquid-gas contacting unit to be moved, in particular to be tilted, i.e. the longitudinal axis of the column 100 is no longer vertical.

In the following, the verb “to move” is intended to refer to an oscillation movement according to one of the six degrees of freedom (yaw, pitch, roll, heave, sway, thrust) and any of their combination.

As mentioned above, a problem in the operation of an oscillating liquid-gas contacting unit 1 is the liquid maldistribution in the packed bed 110, 120 resulting in the formation of wetted zones in said packed beds 110, 120, each wetted zone having a specific liquid load, thereby resulting in an inhomogeneity of the gas treatment and a global loss of efficiency of the liquid-gas contacting unit 1.

This drawback is overcome by the external pipe 140 of the liquid-gas contacting unit 1 of the present invention. Indeed the gas 9, directed from the lower packed bed 110 to the higher packed bed 120 through the external pipe 140, is mixed inside the external pipe 140 so that a homogeneous gas is distributed to the higher packed bed 120. It has been discovered that this results in a more homogenized treatment of the gas flowing upwards and the efficiency of the liquid-gas contacting unit 1 is improved. It has also been discovered that the efficiency of the liquid-gas contacting unit 1 is further improved when the temperature of the gas is changed inside the external pipe 140 between the inlet end and outlet end thereof.

External Pipe

The external pipe 140 may comprise at least one curved portion. If the external pipe 140 comprises at least one curved portion, it may comprise two or more straight portions and one or more curved portions, each connecting two straight portions to each other. In this latter case, it may alternatively consist of only one curved portion with or without any point of inflection.

The number of external pipes 140 is a compromise between the acceptable pressure drop through the column 100 and the internal cross section of the external pipes 140, and is adapted to the number of gas-tight liquid collecting and redistributing devices 130 and packed beds 110, 120 comprised inside the column 100 of the liquid-gas contacting unit 1.

The number of external pipes 140 may be first determined according to the maximum acceptable pressure drop through the column 100 and to their mean inner section and then rounded off to the closest greater integer. Advantageously, increasing the number of external pipes reduces the pressure drop through the column 100 and thus improves the efficiency of the liquid-gas contacting unit 1.

The liquid-gas contacting unit 1 may comprise n gas-tight liquid collecting and redistributing devices 130, numbered from 1 to n, n+1 packed beds 110, 120 numbered from 1 to n+1 inside the column 100, and n external pipes numbered from 1 to n outside the column 100, n being an integer. In particular, the gas-tight liquid collecting and redistributing device j is positioned between packed bed j and packed bed j+1 positioned above packed bed j and the inlet end of external pipe j is positioned between packed bed j and gas-tight liquid collecting and redistributing device j, and the outlet end of external pipe j is positioned between packed bed j+1 and gas-tight liquid collecting and redistributing device j, j being an integer from 1 to n.

The liquid-gas contacting unit 1 may further comprise m external pipes 140, with m an integer, the inlet ends 141 of the m external pipes 140 being positioned between the lower pack bed and the gas-tight liquid collecting and redistribution device and the outlet ends 142 of the m external pipes 140 being positioned between the higher pack bed and the gas-tight liquid collecting and redistributing device.

The features of the two preceding paragraphs may be combined so that the liquid-gas contacting unit 1 may comprise n gas-tight liquid collecting and redistributing devices 130, numbered from 1 to n, n+1 packed beds 110, 120 numbered from 1 to n+1 inside the column 100, and n×m external pipes outside the column 100, n and m being two integers. The external pipes are sorted into n pipe groups of m external pipes, each pipe group being numbered from 1 to n. Thus, the gas-tight liquid collecting and redistributing device j is positioned between packed bed j and packed bed j+1 positioned above packed bed j and the inlet ends of the m external pipes of pipe group j are positioned between packed bed j and gas-tight liquid collecting and redistributing device j, and the outlet ends of the m external pipes of pipe group j are positioned between packed bed j+1 and gas-tight liquid collecting and redistributing device j, j being an integer from 1 to n. The value of n depends on the height of the column 100. Typically, the value of n may be 1 to 5, in particular 1 to 3

The value of m depends on the internal cross section of the column 100. In one embodiment, the value of m is higher than n, in particular 2 to 10, more particularly 2 to 3, for example m equals k.n, k being an integer. In one embodiment, the value of m is lower than n, in particular 1 to 4. In one embodiment m equals n.

For two different j, the value of m may be the same or may vary. That is, the pipe groups independently comprise 1 to m external pipes, in other words, the pipe groups do not necessarily comprise the same number of external pipes.

The m external pipes 140 are generally homogeneously distributed throughout the column 100. An homogeneous distribution can improve the uniform distribution of the gas 9 from the lower packed bed 110 to the higher pack bed 120, thereby improving the efficiency of the liquid-gas contacting unit 1.

Preferably, the virtual axis joining the inlet and outlet ends of an external pipe, when there are more than one between the lower and upper packed beds, is not collinear with the axis of the column 100 so that the effect of liquid maldistribution can be counteracted. The external pipes 140 may be all of the same length or of different lengths.

The external pipes 140 may be all of the same internal mean cross section or of different internal mean cross section, for example 2 to 5 internal mean cross section. For example, the inner cross section of the external pipe can be substantially circular, elliptic.

The inner cross section of the external pipe 140 may be adapted to the nature of the gas and the gas flow to generate turbulence in the gas flow so that the gas is mixed.

Typically, the external pipe 140 can have an internal cross section and an internal mean cross section Sₚᵢ. The sum of the internal means cross sections of all external pipes 140 between two given packed beds is lower than 20% of the internal mean cross section of the column S_{ci}, preferably higher than 0.1% of S_{ci}.

The internal cross section of the external pipe 140 may be constant along its length. The internal cross section of the external pipe 140 may also vary along its length.

Advantageously, if the internal mean cross section of the external pipe 140 is lower than 20% of S_{ci}, the internal mean cross section of the column 100, then the gas 9 flowing through the external pipe 140, is mixed and homogenized in the external pipe 140.

Alternatively, if for at least one point, the internal cross section of the external pipe 140 is lower than 20% of S_{ci}, the internal mean cross section of the column 100, then the gas 9 flowing through the external pipe 140, is advantageously mixed and homogenized in the external pipe 140.

Gas-Tight Liquid Collecting and Redistributing Device

In the liquid gas-contacting unit 1 of the present invention, the liquid collecting and redistributing device 130 is gas-tight.

The gas-tight liquid collecting and redistributing device 130 comprises a plate presenting an upper surface, a lower surface, a lateral wall and at least one orifice.

The plate may have a shape and dimensions adequate to enable the gas-tight liquid collecting and redistributing device 130 to be tightly fixed to the inner surface of the column 100 for example by welding, gasketing, bolting, screwing, clamping or fit-pressing. Advantageously, such tight fixation increases the quantity of gas directed to the external pipe 140 by ensuring that all the gas is directed thereto and thereby improving the efficiency of the liquid-gas contacting unit 1.

The upper surface of the plate is intended to receive and collect the liquid streaming downwards from the higher packed bed 120.

The upper surface may be flat, concave, convex, or corrugated. If the upper surface is concave the liquid is collected at its lowest portion, preferably its lowest portion is at its center. If the upper surface is convex the liquid is collected at its peripheral edges. If the upper surface is corrugated the liquid is collected at the bottom of the waves or folds.

The at least one orifice is intended to let the liquid pass through the plate and is positioned where the liquid is collected. For example, if the upper surface is concave, the at least one orifice may be located at the lowest portion of the upper surface, preferably its lowest portion is at its center. If the upper surface is convex the at least one orifice may be located at its peripheral edges. If the upper surface is corrugated, the at least one orifice may be located at the bottom of the waves or folds.

The gas-tight liquid collecting and redistributing device 130 may further comprise a liquid-collecting tube comprising a liquid inlet end, a liquid outlet end and a peripheral wall between the liquid inlet end and the liquid outlet end. Typically the liquid-collecting tube may pass through the gas-tight liquid collecting and redistributing device disposed between the lower and the higher packed bed inside the column 100. Since it is gas tight, the gas 9 cannot flow upwards around or inside the liquid collecting tube to the upper packed bed 120.

The height of the peripheral wall may be adapted so that the pressure resulting from the amount of liquid presents between the liquid inlet and the liquid outlet is higher than the pressure resulting from the gas 9 to avoid said gas 9 to flow through the liquid-collecting tube and thus through the gas-tight liquid collecting and redistributing device 130.

The height of the peripheral wall may be adapted so that the movements of the liquid-gas contacting unit 1 do not alter the liquid distribution by the gas-tight liquid collecting and redistributing device 130, in particular to insure a homogeneous distribution of the liquid to the lower packed bed 110.

If the gas-tight liquid collecting and redistributing device 130 comprises one orifice, then the liquid-collecting tube is fluidly connected to said orifice so that the liquid can flow through the plate, enter through the liquid inlet end into the liquid-collecting tube and exit the liquid-collecting tube through the liquid outlet end.

If the gas-tight liquid collecting and redistributing device 130 comprises more than one orifice, then one liquid-collecting tube can be fluidly connected to each orifice or to more than one orifice. Therefore, the liquid can flow through the plate, enter through all the liquid inlet ends into all the liquid-collecting tubes fluidly connected to the orifices and exit all the liquid-collecting tubes through all the liquid outlet ends. In this case, part of the liquid outlet ends or all the liquid outlet ends can be fluidly connected so as to form a global liquid outlet end.

Since the liquid collecting and redistributing device 130 is gas-tight, the cylindrical liquid-collecting tube, fit tightly within the orifice or the peripheral wall of the liquid inlet end is tightly fixed to the lower surface of the plate, thereby surrounding one or more orifices.

The gas-tight liquid collecting and redistributing device 130 may further comprise a liquid distributor known by the skilled person, such as a Sparger-typed liquid distributor. The liquid distributor may be fluidly connected to the at least one orifice, to the liquid outlet end of the liquid-collecting tube or to the global liquid outlet end of the liquid-collecting tubes.

Since the liquid collecting and redistributing device 130 is gas-tight, the liquid distributor may be tightly fitted within the orifice or tightly fixed to the lower surface of the plate, thereby surrounding one or more orifices. The liquid distributor may also be tightly fitted within or tightly fixed to the liquid outlet end of the liquid-collecting tube or to the global liquid outlet end of the liquid-collecting tubes. The liquid distributor may also be tightly fitted within or tightly fixed to the liquid outlet end(s) of the liquid-collecting tube(s) and the global liquid outlet end of the liquid-collecting tubes.

The gas-tight liquid collecting and redistributing device 130 homogenizes the liquid collected from the higher packed-bed 110 by the upper surface of the plate and distributes this homogenized liquid to the lower-packed bed. Advantageously, the gas-tight liquid collecting and redistributing device 130 improves the efficiency of the liquid-gas contacting unit 1 by limiting the liquid maldistribution throughout the column 100.

Gas Mixer

The liquid-gas contacting unit 1 may further comprise a device improving the gas mixing inside the external pipe. This device, named gas mixer, causes the gas 9 flowing through the external pipe 140 to mix so that the homogeneity of the gas exiting the external pipe 140 through the outlet end 142 is improved, thereby improving the efficiency of the liquid-gas contacting unit 1. The number of gas mixers is adapted to the number of external pipes.

Typically, the gas mixer may be static one or more mixers, one or more orifice plates, one or more blades or one or more baffles.

Wording “static mixer” is understood as a device for the continuous mixing of gas. Typically a “static mixer” comprises static elements placed inside the external pipe 140 forming obstacles in the way of the gas flow. It forces the movement of the gas resulting in mixing of the gas. In particular, one design of static mixer is the plate-type mixer. Static mixer size depends on the internal cross section of the external pipe 140 and the acceptable pressure drop between the higher packed bed 120 and the lower packed bed 110. Other static mixers can consist in devices achieving a reduction of the section of passageway of the gas, they can be venturi type orifices, valves, or half plates installed in series or bars obstructing the section of passageway of the gas.

Wording “orifice plate” is understood as a plate with one or more holes. The gas is forced to converge to pass through the hole(s) and is thus mixed and homogenized due to turbulences created by the hole(s). The size of the orifice plate depends on the internal cross section of the external pipe 140 and the acceptable pressure drop between the higher packed bed 120 and the lower packed bed 110.

Typically the size of the static mixer and of the orifice are calculated so that the acceptable pressure drop between the higher packed bed 120 and the lower packed bed 110 may be 5 mbar to 100 mbar, in particular 25 mbar to 75 mbar, more particularly 50 mbar.

Heat-Exchanger

The liquid-gas contacting unit 1 may further comprise a heat exchanger with which the gas flowing through the external pipe 140 is put into thermal contact. Typically the heat exchanger is connected to the external pipe 140. Typically, the heat exchanger is positioned outside the column 100.

In the following, “heat exchanger” is understood as an air cooler using external air to cool or heat a fluid, gases or liquids or as any mechanical device fed with a heat transfer fluid, being cooling or heating fluid, to cool or heat a fluid, gases or liquids. The heat transfer fluid may be water, a solution of ethylene glycol, a solution of diethylene glycol, a solution of propylene glycol, compressed air, gaseous or liquid CO₂, gaseous or liquid nitrogen, propane or natural gas, hot oil or heating steam.

In the following, “thermally in contact” and “thermal contact” means disposed one relative to the other so that heat exchange occurs. In particular two devices are thermally in contact when their fluids (gases or liquids) are intended to exchange heat.

Since the gas 9 flowing through the external pipe 140 is put into thermal contact with a heat exchanger, said gas 9 may exchange heat with external air or the heat transfer fluid so as to change the temperature of said gas 9 inside the external pipe 140, i.e. cooling or heating said gas 9. Advantageously, the heat exchanger increases efficiency of the column.

Typically, the heat exchange is improved when the contact surface between the heat exchanger and the gas flowing through the external pipe 140 is increased, for example by using baffles, inside the external pipe 140. Advantageously, these baffles also form obstacles which mix the gas 9 flowing through the external pipe 140 so that its mixing is improved.

Advantageously, the heat exchanger acts as a gas mixer because it obstructs the passage of the gas.

The number of heat-exchanger is adapted to the number of external pipes. For example, in the case there are m external pipes, there may be from one heat exchanger to as many heat exchangers as external pipes. Preferably there are either one heat exchanger or as many heat exchangers as external pipes. In the case there are m external pipes sorted into n pipe groups, there may be one heat exchanger per pipe group or one heat exchanger for each individual external pipe. Any number of heat exchangers and grouping of external pipes may also be considered. Finally, some of the external pipes may not be in thermal contact with any heat exchanger.

Typically the acceptable pressure drop between the higher packed bed 120 and the lower packed bed 110 may be 50 mbar to 700 mbar, in particular 100 mbar to 350 mbar, if a heat exchanger is connected to the external pipe 140.

Gas Redistributor

The external pipe 140 redirects the gas exiting through the outlet end 142 to the higher packed bed 120. Nevertheless to improve the uniformity of the gas redirection, the liquid-gas contacting unit 1 may further comprise a gas redistributor between the higher packed bad 120 and the gas-tight liquid collecting and redistributing device 130

In the following, “gas redistributor” is understood as any device used to uniformly redirect the homogenous gas exiting the external pipe 140 through the outlet end 142 to the higher packed bed 120.

Typically, a gas redistributor may be a gas dispenser, gas deflector or a gas distributor plate with one or more chimneys or a vapor horn gas distributor.

Advantageously, the homogenous gas is uniformly redistributed by the gas redistributor to the higher packed bed 120, thereby improving the efficiency of the liquid-gas contacting unit 1.

The gas redistributor can be tightly fixed to the outlet end 142 of the external pipe 140.

In case there are m external pipes between the lower and upper packed beds, the outlet ends of all external pipes are preferably connected to the same and only gas redistributor.

Method

Another aspect of the invention is a method for improving the efficiency of a liquid-gas contacting unit 1 comprising for example a column 100, at least a lower packed bed 110 and a higher packed bed 120 positioned higher than the lower packed bed 110 inside the column 100, a gas-tight liquid collecting and redistributing device 130 disposed between the lower and the higher packed bed 110, 120 inside the column 100, and an external pipe 140 outside the column 100, the external pipe 140 comprising an inlet end 141, an outlet end 142 and a peripheral wall 143 between the inlet end 141 and the outlet end 142, the inlet end 141 of the external pipe 140 being positioned between the lower pack bed 110 and the gas-tight liquid collecting and redistributing device 130 and the outlet end 142 of the external pipe 140 being positioned between the higher pack bed 120 and the gas-tight liquid collecting and redistributing device 130.

The method of the present invention comprises directing the gas from the lower packed bed 110 to the higher packed bed 120 through the external pipe 140.

The gas is first introduced into the column 100 of liquid-gas contacting unit 1 through the gas inlet 102, while the liquid is introduced through the liquid inlet 104.

If the column 100 comprises more than two packed beds, the gas from a lower packed bed 110 is redirected to a higher packed bed 120 through the external pipe 140. This sequence is repeated from the gas inlet 102 until the gas is recovered through the gas outlet 103. Further, unlike the methods of the prior art, between two packed beds, the gas is mixed and homogenized inside the external pipe 140, i.e. outside the column 100.

As previously explained, according to the method of the present invention, the homogeneity and the efficiency of the gas treatment through the column 100 of the liquid-gas contacting unit 1 are improved.

The method of the present invention may be carried out so that the pressure drop between the higher packed bed 120 and the lower packed bed 110 is 5 mbar to 100 mbar, in particular 25 mbar to 75 mbar, more particularly 50 mbar.

Typically, the pressure drop depends on the gas flow, the internal mean cross section of the column 100, the internal mean cross section of the external pipe 140, and the number of external pipe 140.

A gas flow comprises in the above ranges facilitates the mixing of the gas flowing through the external pipe 140 and the formation of a homogenous gas. Moreover, the pressure drop is reduced. Advantageously, the efficiency of the method of the present invention is improved.

If the liquid-gas contacting unit 1 further comprises a heat exchanger, to which the gas flowing through the external pipe 140 will be put into thermal contact, then the temperature of the gas 9 may be changed inside the external pipe 140, i.e. the gas 9 may be cooled or heated between the inlet end and outlet end of the external pipe 140.

The efficiency of the gas treatment through the column 100 of the liquid-gas contacting unit 1 comprising said heat exchanger is thus even further improved. This adds to the mixing of gas favored by the heat exchanger.

Typically, the temperature change of the gas between the inlet end and outlet end of the external pipe 140 may be −50° C. to +50° C., in particular −30° C. to +30° C.

Typically the acceptable pressure drop between the higher packed bed 120 and the lower packed bed 110 may be 50 mbar to 700 mbar, in particular 100 mbar to 350 mbar, if a heat exchanger is connected to the external pipe 140

The following examples provide another non-limiting illustration of the invention.

### EXAMPLES

### Example 1: CO₂ Absorption Unit Wherein the Liquid Solvent is a Mixture of Amines

The liquid-gas contacting unit, being a CO₂ absorption unit, comprises a column having an internal mean cross section of 20.4 m², four packed beds, and three gas-tight liquid collecting and redistributing devices. The packed beds and the gas-tight liquid collecting and redistributing devices are disposed alternately inside the column so that between two successive packed beds there is on gas-tight liquid collecting and redistribution device.

The liquid-gas contacting unit further comprises six external pipes outside the column, so that there are two external pipes between two successive given packed beds.

The physicochemical properties of the gas to be treated by the liquid-gas contacting unit are presented in Table 1 below.

Since the flow rate of the gas to be treated is set at 580,000 Sm³/h and the pressure drop between two pack beds is set at 50 mbar, the internal mean cross section Sₚᵢ of each external pipe is 1.1 m².

TABLE 1
Gas to be treated

| | |
|---|---|
| Pressure (bar) | 70 |
| Temperature (° C.) | 30 |
| Amount of CO₂ (% mol) | 17 |
| Density (kg/m³) | 71 |
| Molar Mass (kg/kmol) | 22 |

With a tilting angle of the liquid-gas contacting unit being 5°, the flow rate of amine in the liquid-gas contacting unit necessary to reduce the amount of CO₂ to less than 50 ppmv in the gas to be treated is decreased to 1900 Sm³/h. In the same conditions, the flow rate of amine in a classical CO₂ absorption unit is 2150 Sm³/h.

The efficiency of the liquid-gas contacting unit is thus almost 12% better than the efficiency of a classical CO₂ absorption unit.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A liquid-gas contacting unit comprising:
a column,
at least a lower packed bed and a higher packed bed positioned higher than the lower packed bed inside the column,
a gas-tight liquid collecting and redistributing device disposed between the lower packed bed and the higher packed bed inside the column;
an external pipe outside the column, the external pipe comprising an inlet end, an outlet end and a peripheral wall between the inlet end and the outlet end; wherein the inlet end of the external pipe is positioned between the lower pack bed and the gas-tight liquid collecting and redistributing device; and the outlet end of the external pipe is positioned between the higher pack bed and the gas-tight liquid collecting and redistributing device.

2. The liquid-gas contacting unit of claim 1, wherein the column has an internal mean cross section S_{ci} and the external pipe an internal mean cross section Sₚᵢ, such that Sₚᵢ is 0.1% to 20% of S_{ci}.

3. The liquid-gas contacting unit of claim 1, further comprising a gas mixer inside the external pipe.

4. The liquid-gas contacting unit of claim 1, further comprising a heat exchanger with which a gas flowing through the external pipe is put into thermal contact.

5. The liquid-gas contacting unit of claim 1, further comprising a gas redistributor between the higher pack bed and the gas-tight liquid collecting and redistributing device.

6. The liquid-gas contacting unit of claim 1 comprising n gas-tight liquid collecting and redistributing devices numbered from 1 to n, n+1 packed beds numbered from 1 to n+1 inside the column and n external pipes numbered from 1 to n outside the column,
wherein gas-tight liquid collecting and redistributing device j is position between packed bed j and packed bed j+1 above packed bed j,
wherein the inlet end of external pipe j is positioned between packed bed j and gas-tight liquid collecting and redistributing device j, and the outlet end of external pipe j is positioned between packed bed j+1 and gas-tight liquid collecting and redistributing device j.

7. The liquid-gas contacting unit of claim 1 comprising m external pipes, with m, an integer, from 1 to 6, wherein the inlet ends of the m external pipes are positioned between the lower pack bed j and the gas-tight liquid collecting and redistributing device j and the outlet ends of the m external pipes are positioned between the higher pack bed j+1 and the gas-tight liquid collecting and redistributing device j.

8. The liquid-gas contacting unit of claim 1, wherein the column presents an inner surface, wherein the gas-tight liquid collecting and redistributing device is tightly fixed to the inner surface.

9. The liquid-gas contacting unit of claim 1 operating under counter-current or co-current liquid-gas flow conditions.

10. The liquid-gas contacting unit of claim 1 being an absorption unit, a separation unit or a heat exchange unit.

11. A method for improving the efficiency of the liquid-gas contacting unit of claim 1, the method comprising the following step:
a) directing a gas from the lower packed bed to the higher packed bed through the external pipe.

12. The method of claim 11, wherein a pressure drop between the higher packed bed and the lower packed bed is 5 mbar to 100 mbar.

13. The method of claim 11, wherein the temperature of the gas is changed inside the external pipe.

14. The method of claim 11, wherein the temperature change of the gas between the inlet end and outlet end of the external pipe is −50° C. to +50° C.

15. A floating support comprising the liquid-gas contacting unit of claim 1.
